(19) United States
(12) Patent Application Publication
(10) Pub. No.: US 2008/0208953 A1
(43) Pub. Date: Aug. 28, 2008

(54) Method for notifying presence information, a presence server, a client and a system

(75) Inventor: Linyi Tian, Shenzhen (CN)

Correspondence Address: LADAS & PARRY LLP, 26 WEST 61ST STREET, NEW YORK, NY, 10023, US

(73) Assignee: HUAWEI TECHNOLOGIES CO., LTD.

(21) Appl. No.: 11/986,943

(22) Filed: Nov. 27, 2007

Related U.S. Application Data
(63) Continuation-in-part of application No. PCT/CN2006/002851, filed on Oct. 25, 2006.

(30) Foreign Application Priority Data
Oct. 26, 2005 (CN) 200510116641.4

(51) Int. Cl. G06F 15/16

(52) U.S. Cl. 709/201; 709/206

(57) ABSTRACT

The present invention provides a method for notifying presence information, a presence server, a client and a system. A watcher subscribes to presence information of the presentity via the presence server. The presence server receives the published message sent by the presentity client or application sever and judges whether the watcher has defined notification rules, if notification rules have been defined, the presence server processes the published message according to content-related process rules predefined by the watcher and presentity and the notification rules. If it is determined that the notification rules have not been defined, the presence server processes the published message according to content-related process rules predefined by the watcher and presentity. The presence server sends the processed published message to the watcher. The notification rules can be predefined in the presence XDMS or the presence server by the watcher, and also can be created in response to subscription. By using the method and system, the presence server can determine whether the user is to be notified and which presence information is to be sent according to the requirement of the user.

The present application is a continuation of PCT application PCT/CN2006/002851, filed on Oct. 25, 2006, entitled “A METHOD FOR NOTIFYING PRESENCE INFORMATION, A PRESENCE SERVER, A CLIENT AND A SYSTEM”, which is incorporated by reference herein in its entirety.

### FIELD OF THE INVENTION

The present invention relates to an information notification technology, and particularly to a method for notifying presence information, a presence server, a client and a system.

### BACKGROUND OF THE INVENTION

Today, the application of Presence Service becomes more and more popular. The Presence Service is a communication service that collects and publishes presence information. With the Presence Service, the watcher can search for chat buddies and query state information of the buddies to implement an instant communication of text and multimedia information according to various terminals to overcome limitations of space and time. Presentation and management of presentity's state can be accomplished by a presence server. In accordance with the presence information, a watcher can know whether the presentity is online, what the presentity is doing (e.g. having a meeting, or having a meal, etc.), his mood, capability of client of the presentity, and preferences, etc. In addition, the presentity can send presence information to watchers by using the Presence Service to share media contents, such as ring tones, pictures, files and so on.

FIG. 1 shows a system architecture that implements the Presence Service in the prior art. The system includes a presentity client or application server, a presence server, a watcher client or application server, and a Presence XDMS (i.e. Presence XML Document Management System). The presence server includes a subscription processing unit, a storage unit, and a publishing and notification processing unit.

The presentity client or application server is a presence information source. Whenever the presence information of the presentity client or application server changes, the presentity client or application server actively sends a PUBLISH message to the presence server to publish the presence information.

The watcher client or application server subscribes for the presence information of the presentity and receives NOTIFY message from the presence server.

The subscription processing unit in the presence server receives SUBSCRIBE message from the watcher client or application server, and judges subscription result according to subscription authorization rules, predefined by the presentity and obtained by the presence server from Presence XDMS. If the subscription result is permission of subscribing, the storage unit is triggered to store a subscription relationship in the presence server.

The publishing and notification processing unit in the presence server is capable of receiving publication request from the presentity client or application server, obtaining a watcher from the storage unit, and notifying of the presence information after processing (combining, composing, content filtering, etc.) the presence information to the watcher client.

The publishing and notification processing unit is the most important unit. FIG. 2 shows its structure. The publishing and notification processing unit includes a presence information composing unit, a content authorization rule checking unit, a watcher filtering unit, a partial notification processing unit and a presence information publishing unit. The presence information composing unit is capable of composing newly published presence information and presence information stored in the server. The content authorization rule checking unit is capable of filtering out the presence information that is not permitted to be published according to the rules (what information is permitted to be notified to a specific watcher client) defined by the presentity; the watcher filtering unit is configured to filter Out the presence information that is not expected to be received according to the Event Notification Filtering rules (e.g., what information from the presentity client is not expected to be received) defined by the watcher; the partial notification processing unit is configured to filter out the information that is not within the range of subscription according to the rules (e.g. only part of the presence information related to watcher location is received.) defined by the watcher when the watcher is performing subscription; the presence information publishing unit is configured to notify the watcher of the processed presence information. In FIG. 2, the content authorization rule checking unit, watcher filtering unit, and partial notification processing unit are optional. When the presentity or the watcher has not defined some of the rules, the corresponding units may be omitted; furthermore, rules described above in the prior art are all content-related process rules.

The Presence XML Document Management System (Presence XDMS) stores authorization rules and group information of the presentity, the authorization rules includes subscription authorization rule, content authorization rule, etc.

The watcher client or application server and the presentity client or application server may be mobile terminals, such as mobile telephones, Personal Digital Assistant (PDAs) or intelligence terminals (e.g. digital set-top boxes), and may also be fixed terminals. Above functions on mobile terminals may also be applied to fixed terminals. At present, the fixed terminals with SIP capability have emerged. There is an application program on the presentity client, which is provided to subscribe to messages. A user may select desired messages from the messages that can be subscribed to, and after the selection is confirmed, the watcher client or application server or the presentity client sends all the messages including the watcher identifier or the presentity identifier to the presence server.

In above implementation solution, the SUBSCRIBE message is a SIP message. The “From” field in the header of SUBSCRIBE message contains the watcher's identity, and the “To” field contains the presentity's identity. If the message body is empty, all presence information of the presentity is subscribed; if the message body contains an XML document that describes the event notification filtering rules, the unwanted content of presence information will be filtered out.

In the existing mechanism, the Subscription Authorization Rule and the Content Authorization Rule are described in an XML document, which includes elements of <Condition>, <Action> and <Transfonmation>.

Element <Condition> indicates the matching conditions, including 1) Identity: the watcher's identity, such as “sip:zhangsan@163.com”; 2) Domain: domain, such as “@163.com”. For a watcher that meets the matching conditions specified in <Condition>, the presence information, such as activity state (in a conference, having a meal, etc.), may be published to this watcher after successful subscription;

Element <Action> indicates the actions to be taken after matching the matching condition, including mainly: allow, block, polite-block (In this process, a subscription success message is returned, but the watcher will never be notified of the presence information, i.e. rejecting politely. For the watcher, it has the same effect as “block”.), and confirm (wait for confirmation);

Element <Transformation> indicates what information is permitted to be notified to the watcher after successful subscription and it is only executed when the information is being published, and is controlled by the presentity.

In the prior art, the event notification filtering mechanism is: when subscribing, the watcher specifies the event notification filtering rules for the content of presence information in the XML document carried in the subscription request, for example, the filtering condition may be that only those elements of presence information that meet specific namespace are to be received, etc.

The subscription request includes two parts: “message header” and “message body”. The “message header” specifies the information of the watcher (subscriber) and the presentity (target to be subscribed); the “message body” contains event notification filtering rules, content of presence information (such as location information, Poc information and the like) to be subscribed and partial notification (subscribe to all information of a specific type, or only subscribe to part of the information). Both the event notification filtering rules and the partial notification may be chosen from.

In the above scheme, the Presence XDMS is separated from the presence server. All kinds of rules are stored in the Presence XDMS. The presentity client uses the XCAP protocol via an Aggregation Proxy, or the Application Server uses the XCAP protocol directly, or the watcher defines and modifies the rules in the Presence XDMS through a user interface (e.g. webpage). In the prior art, the Presence XDMS may also be merged with the presence server and when the rules are stored in the presence server.

With reference to FIG. 3, the processing flow of the existing mechanism will be described in detail.

1) The presentity A performs some definitions in the Presence XDMS first, such as the Subscription Authorization Rule (what kind of watcher is permitted to subscribe) and the Content Authorization Rule (what information is permitted to be published) and so on; the presence server may obtain those rules by using the XCAP protocol, or, if the presence server has subscribed to the change notification for those rules, the Presence XDMS notifies the presence server whenever those rules change. The <namespace> is used in Event Notification Filter to indicate receiving presence information that meets the namespace definition, and <include> is used in <what> to indicate what presence information fields could be received (Only some of the event notification filtering rules are listed);

2) The watcher B requests to subscribe to presence information of presentity A;

3) The subscription processing unit in the presence server receives a SUBSCRIBE message from watcher B. The presence server obtains Subscription Authorization Rules predefined by presentity A from the Presence XDMS, and judges the subscription result according to the Subscription Authorization Rules. If this subscription is permitted, it requests the “storage unit” to store the subscription relationship in the presence server;

4) The presentity A publishes information to the presence server;

5) The publishing and notification processing unit in the presence server receives the publication request from the presentity A, determines the watcher (watcher B) from the “storage unit” and obtains the content-related process rules defined by the presentity A and the watcher from the Presence XDMS or presence server. The following processes are implemented by the publishing and notification processing unit:

The presence information composing unit is used for the newly published presence information and the presence information stored in the server to be integrated together; the content authorization rule checking unit is capable of filtering out the information that is not permitted to be published according to the rules (what information is permitted to be published to a specific watcher client) defined by the presentity; the watcher filtering unit filters out the unwanted information according to the rules defined by the watcher; the partial notification processing unit deletes unchanged information in accordance with the presence information sent to the watcher last time to ensure only notifying information that has changed from the last time the presence information is notified; the presence information publishing unit notifies (NOTIFY) the watcher (i.e. watcher B) of the processed presence information.

In the process of implementing Presence Service provided in the prior art, the watcher may only control the amount of the content of presence information to be published, but is unable to define notification conditions of the presence information, i.e., the watcher is unable to determine whether the presence server will publish messages to her/him or not. In other words, after the presence information is subscribed to by the watcher successfully, once the presence information of the presentity changes, the presence server notifies the watcher of the presence information according to the subscription relationship. In addition, the presence server is also unable to control the publication actions of the presentity client or application server according to the subscription conditions defined by the watcher.

Therefore, the prior art has the following drawbacks in the process of implementing Presence Service:

(1) The watcher is unable to receive presence information according to his/her state, and therefore may receive corresponding presence information which is not desired by the watcher, for example, the watcher may receive presence information that disturbs his/her rest during the break time, or the watcher may receive presence information, such as game information, that disturbs his/her normal work when the watcher is working;

(2) When the watcher's terminal is not in need of receiving the presence information at all times, the presence server still has to process and publish the presence information for the watcher, resulted in increased load on the presence server and the network; furthermore, when the received presence information needs to be processed on the watcher's terminal at all times, this causes unnecessary battery power consumption;

(3) The publication actions of the presentity client or application server can not be controlled according to the requirement of the watcher; invalid information is transmitted through the network, resulting in a waste in network bandwidth.

### SUMMARY OF THE INVENTION

A method for notifying presence information, a presence server, a client and a system are provided according to the embodiment of the present invention, so that a server may send notifications to a watcher client conditionally according to the notification rules defined by the watcher client; therefore, the watcher client may flexibly choose whether to receive presence information or not, and the resources occupied in the Presence Service implementing procedures may be saved effectively.

To achieve the above object, the following technical solution is provided according to some embodiment of the present invention:

Firstly, a method for notifying presence information is provided according to an embodiment of the invention, including:

A watcher subscribes to the presence information of a presentity through a presence server;

The presence server receives the PUBLISH message from the presentity client or application server, and determines, according to the correspondence notification rules defined by the watcher, whether to publish the message to the watcher, and the notification rules are defined as conditions for determining whether to send presence information to the watcher.

A system for notifying presence information, including a presence server, is also provided according to an embodiment of the present invention, and the presence server includes a publishing and notification processing unit. The system further includes a notification rule processing unit.

The publishing and notification processing unit finds the watcher according to the subscription relationship, interacts with the notification rule processing unit to obtain the judgment result from the notification rule processing unit, and then determines whether to publish the message to the watcher according to the judgment result;

The notification rule processing unit judges whether the notification conditions are satisfied according to the notification rules and sends the result of judgment to the publishing and notification processing unit.

An embodiment of the present invention also provides a presence server which includes a publishing and notification processing unit and a notification rule processing unit.

The publishing and notification processing unit finds the watcher according to the subscription relationship, interacts with the notification rule processing unit to obtain the judgment result from the notification rule processing unit, and then determines whether to publish the message to the watcher according to the judgment result;

The notification rule processing unit judges whether the notification conditions are satisfied according to the notification rules and provides the result of judgment to the publishing and notification processing unit.

A client is further provided according to an embodiment of the present invention, including a notification rule transmission unit, which is configured to send to the presence server determined conditions for determining whether to send presence information to the notification rule transmission unit, as the notification rules.

A method for notifying presence information is further provided according to an embodiment of the present invention, including:

A watcher subscribes to the presence information of a presentity through a presence server;

The presence server determines whether to publish presence information to the watcher according to the state of the watcher and the notification rules based on the state of the watcher. The notification rules are the conditions for sending presence information to the watcher, which are defined according to the state of the watcher.

With above technical solution of the invention, the watcher is able to define and update the notification rules by means of the SUBSCRIBE message, so that the receiving frequency, receiving validity period, receiving duration, and the number of receptions, etc. of presence information by the watcher can be controlled, and the presence server may be required to determine whether to send presence information to corresponding watcher according to its state. In the present invention, when necessary, the presence server may require, according to the subscription requests from all watchers, the presentity client or application server to control the publication actions.

Therefore, with the implementation of the present invention, a watcher may control the presence server to notify him/her of the presence information or not as required, and thereby the resources of the presence server and the network resources may be utilized more reasonably, such that the notification of presence information becomes more reasonable and personalized. The subscriber (watcher) may decide, according to the real situation, whether to receive the published information or not and what published information will be received, so as to avoid receiving unwanted presence information, and this is especially suitable for Presence Service in wireless communication networks with limited network resources. Other features, objects, and efficacies of the present invention will be understood more clearly and easily in the description in preferred embodiments of the present invention, with reference to the accompanying drawings.

### BRIEF DESCRIPTION OF THE DRAWINGS

FIG. 1 is a diagram illustrating the system architecture for implementing Presence Service in the prior art;

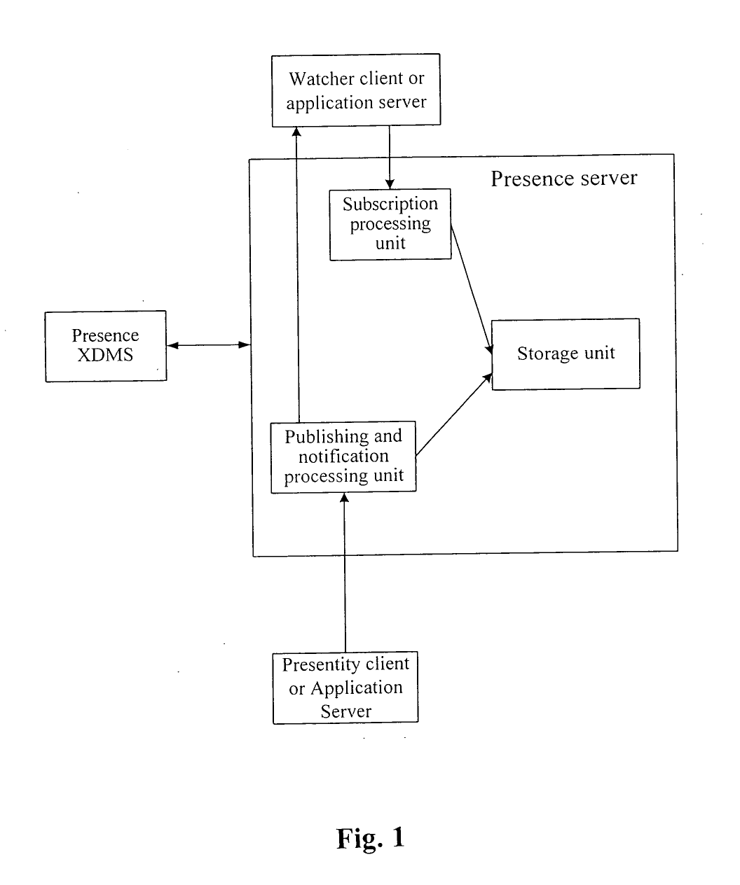

FIG. 2 is a diagram illustrating the system architecture of the publishing and notification processing unit in the prior art;

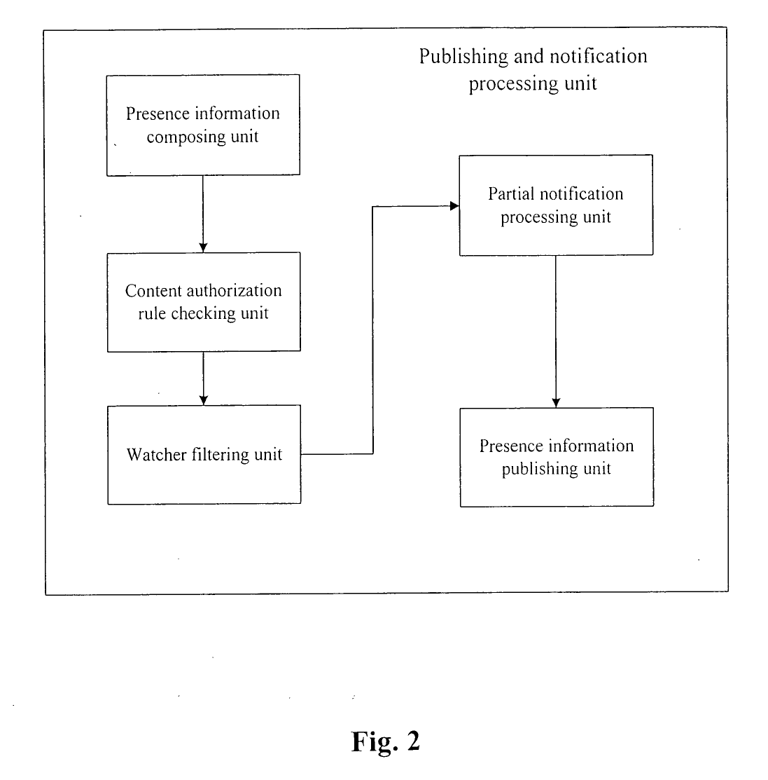

FIG. 3 is a flowchart of implementing the technical scheme in the prior art;

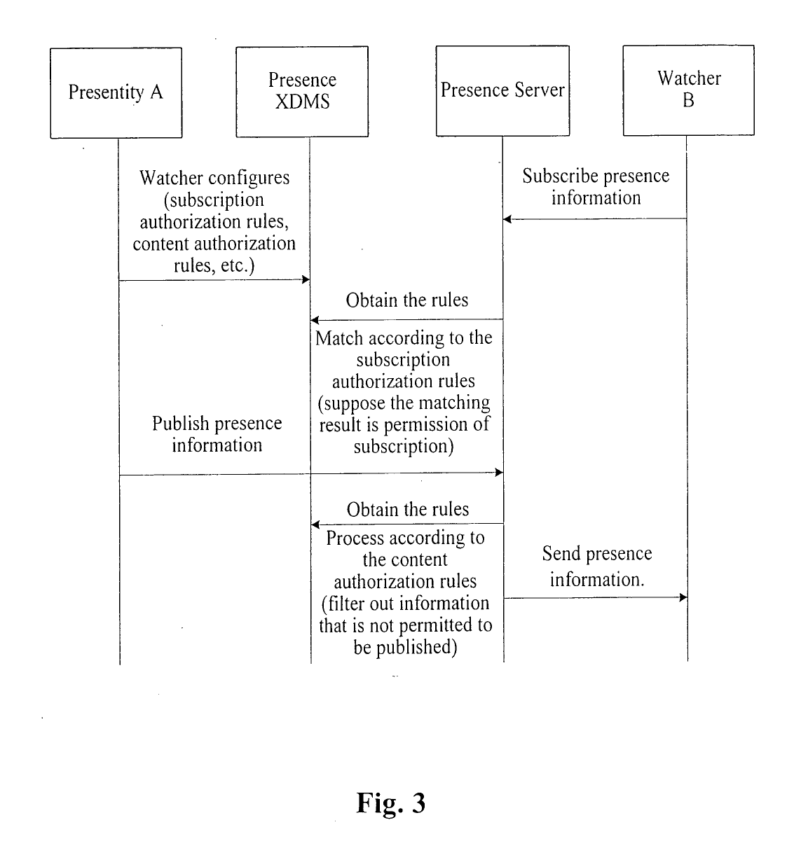

FIG. 4 is a diagram illustrating the structure of the system according to an embodiment of the present invention;

FIG. 5 is a schematic diagram illustrating the subscription and publication flow according to an embodiment of the invention;

FIG. 6 is a flowchart illustrating the subscription processing according to an embodiment of the invention;

FIG. 7 is a flowchart illustrating the publication processing according to an embodiment of the invention;

FIG. 8 is a flowchart illustrating the notification rules defined by the watcher according to an embodiment of the invention;

In all of above drawings, identical symbols indicate identical, similar, or corresponding characteristics or functions.

### DETAILED DESCRIPTION OF THE EMBODIMENTS

The present invention will be further described with reference to the accompanying drawings as follows.

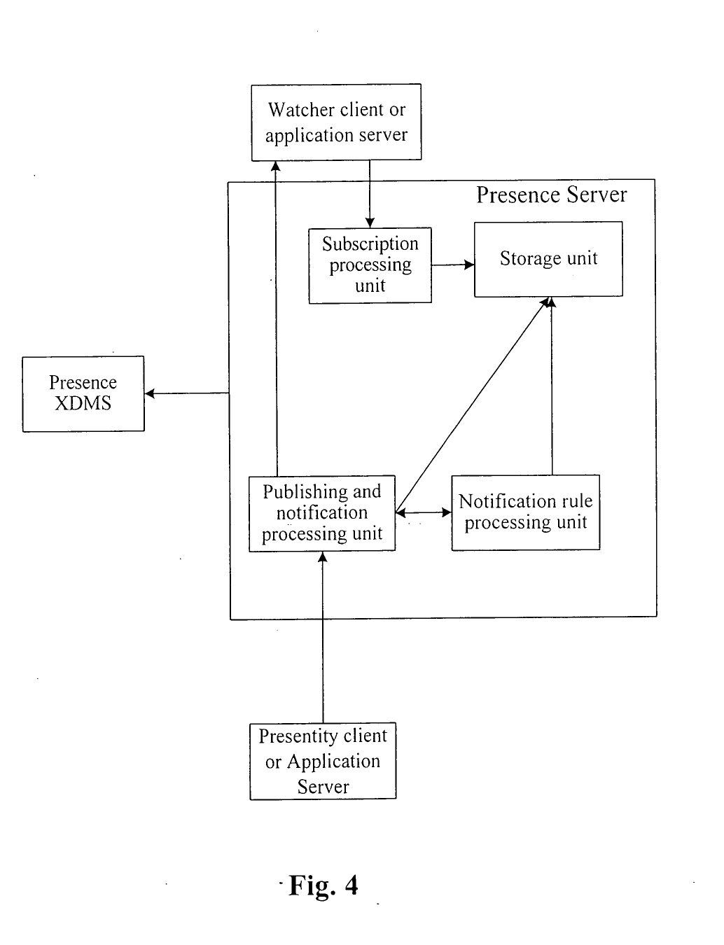

Referring to FIG. 4, a system of the presence invention includes a presentity client or application server, a presence server, a watcher client witch may also be application server, or any entity with watcher function, and a Presence XML Document Management System (Presence XDMS). The presence server includes a subscription processing unit, a storage unit, a publishing and notification processing unit and a notification rule processing unit. The notification rule processing unit is newly added according to an embodiment of the invention. The notification rule processing unit is configured to determine that the presence server to send presence information to a watcher client or not at a predefined time or under other conditions according to receiving policies (i.e., notification rules) defined by the watcher client, so that the watcher may flexibly customize the conditions, such as time condition, working state condition, for receiving presence information as required, and, if the conditions are not satisfied, the presence server may not send presence information to the watcher client, therefore, the watcher may control the actions of publishing presence information as required according to the predefined conditions.

In the present invention, the watcher client is also improved in the way that a notification rule transmission unit is configured in the watcher client for sending the conditions for determining whether to notify the watcher of the presence information, as the notification rules, to the presence server, so as to define or update the notification rules in the presence server.

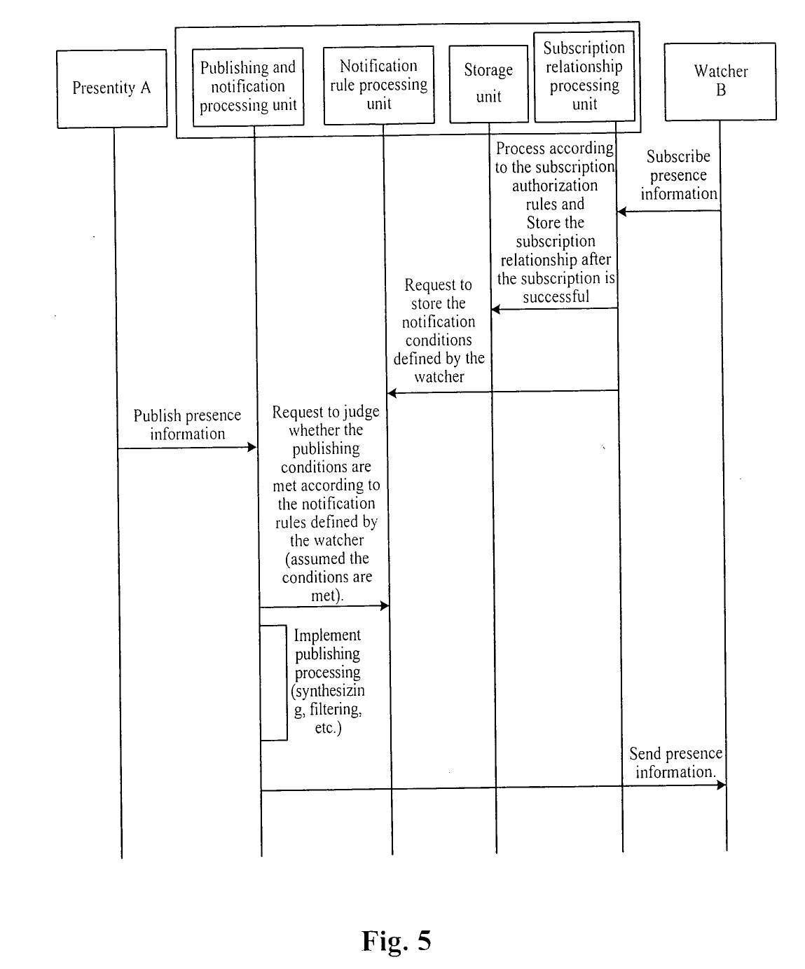

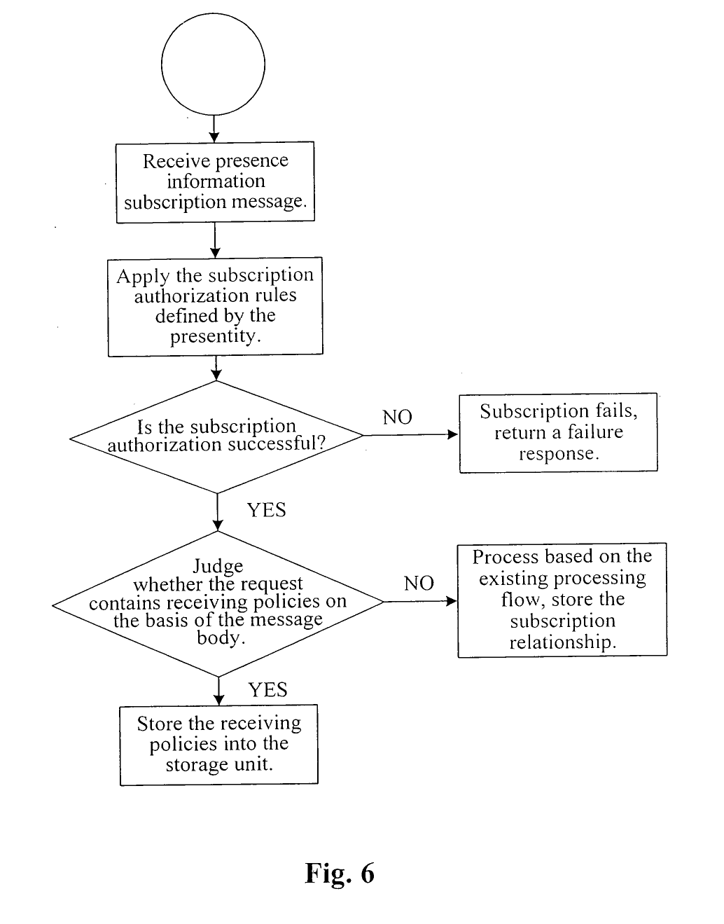

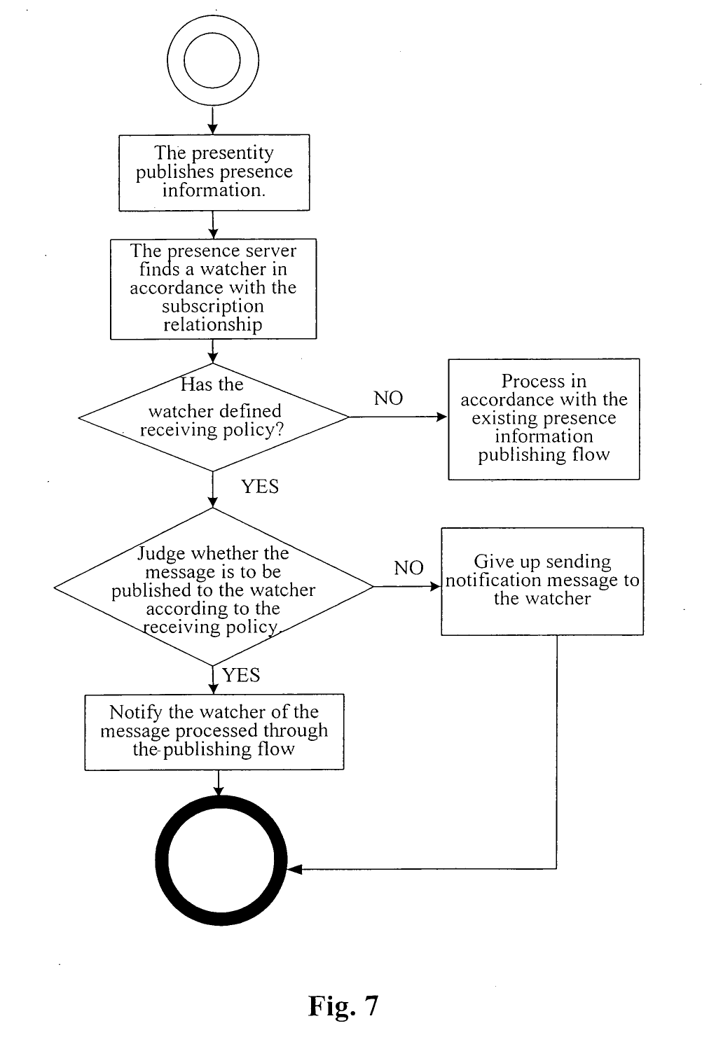

As shown in FIGS. 5-7, the specific subscription and publication process according to an embodiment of the invention is provided as follows:

1) The watcher client B sends a subscription request to the subscription processing unit in the presence server to subscribe to the presence information from presentity client A;

2) The subscription processing unit performs the processing according to the Subscription Authorization Rules in the Presence XDMS. If subscription authorization fails, the subscription processing unit returns a subscription failure response; if the subscription authorization succeeds, the subscription processing unit stores subscription relationship into the storage unit, and then judges whether the notification rules are defined in subscription request. If the receiving policies (i.e., notification rules) are not set, the processing procedures for the subscription request is terminated, and if the notification rules have been set, the notification rules will be stored into the storage unit as the basis for the notification rule processing unit to control sending of presence information to the watcher client. Of course, unit in which the notification rules is stored may be determined flexibly as required, for example, the notification rules may also be stored in the notification rule processing unit or any unit with storage capability in the presence server, or the Presence XDMS;

3) The presentity client A publishes the presence information to the presence server via the publishing and notification processing unit;

4) The publishing and notification processing unit finds the watcher B in accordance with the subscription relationship, and sends a query to the notification rule processing unit. The notification rule processing unit judges whether notification rules are defined by watcher client B according to the query. If the notification rules are set, the notification rule processing unit judges whether the notification conditions are satisfied and returns a response to the publishing and notification processing unit, and perform process 5); if no notification rule is set, the publishing and notification processing unit performs the publication processing of the presence information for watcher B in accordance with the existing presence information publication flow;

5) If the response indicates that the notification conditions are satisfied, the publishing and notification processing unit performs the publication processing of the presence information (including information combination, content authorization, and event notification filtering, etc.), and sends the presence information to watcher client B. If the response indicates the notification conditions are not satisfied, the publishing and notification processing unit does not publish the presence information to the watcher client B;

Although only the case of the notification rule processing unit being arranged in the presence server is described in this embodiment, those skilled in the art should understand that the notification rule processing unit may also be arranged in the publishing and notification processing unit in the presence server or in other physical unit, or the notification rule processing unit may be arranged separately and carries out interaction with corresponding unit in the presence server via a related communication interface. No matter how the notification rule processing unit is arranged, it attains the same purpose. In addition, the notification rules may also be a part of the subscription relationship, i.e. the subscription relationship and the notification rules may be stored and managed together instead of stored separately.

The notification rules in the present invention may not be defined during the subscription; instead, it may be predefined by the watcher in the Presence XDMS or presence server. The notification rule processing unit in the presence server may obtain the notification rules from the Presence XDMS or presence server, and then process accordingly based on the notification rules. The content authorization rules in the Presence XDMS are modified and set via the XCAP protocol by the presentity; the Event Notification Filtering conditions are modified and updated by the watcher client by sending a Subscription Refresh Request.

In the present invention, the notification rules may be defined and modified through either of the following two ways:

(1) The notification rules are defined initially in the SUBSCRIBE message, and then the notification rules may be modified by means of the Subscription Refresh Request;

(2) The notification rules may be defined and modified through other ways. For example, the presence server may provide a WEB interface to the watcher, to enable the watcher to view the subscribed list of presentities and define the notification rules initially or modify corresponding notification rules on the WEB interface.

In this embodiment, both the watcher client and the presentity client may also be application server. The Application Server may be a gaming server or a server with similar function, or an instant message server (e.g., ICQ/MSN server).

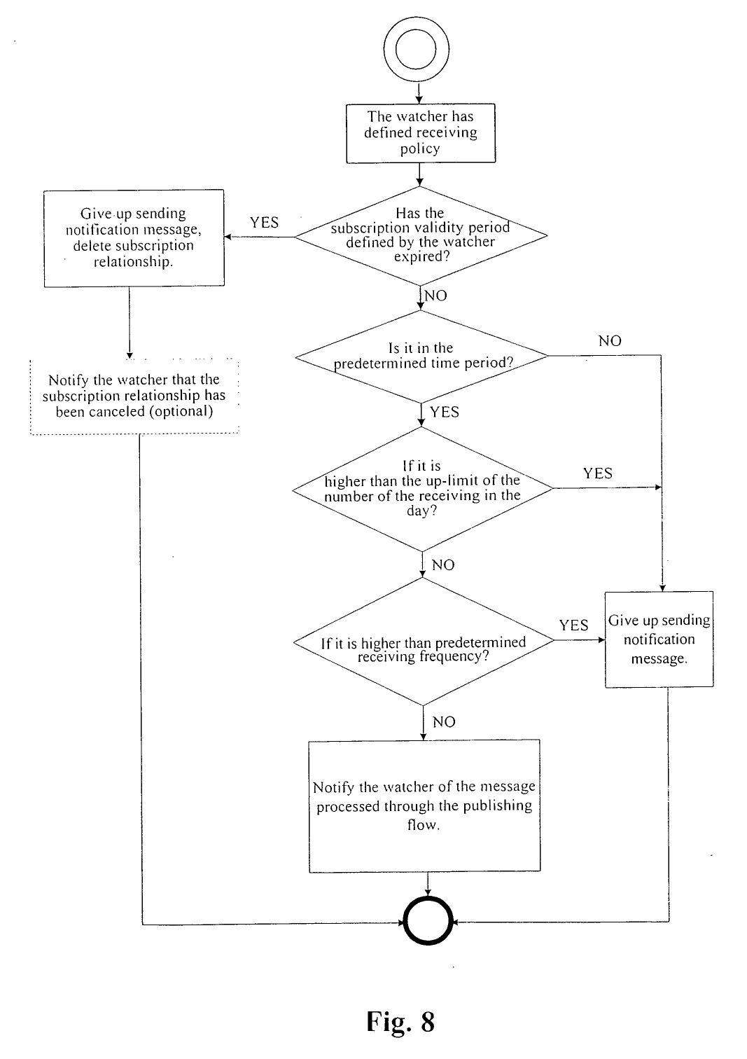

Referring to FIG. 8, the processing flow of the watcher's subscription policy will be described in detail as follows:

1) The notification rule processing unit determines that notification rules have been defined by the watcher. Firstly, the notification rule processing unit judges whether subscription validity period set by the watcher has expired. If the subscription validity period has expired, the notification rule processing unit notifies the publishing and notification processing unit to give Lip the transmission of the notification message and deletes the subscription relationship stored in the storage unit. The notification rule processing unit may also notify the watcher client that the subscription relationship has been canceled; if the subscription validity period has not expired, performs process 2). For the subscription validity period, in case of the watcher setting the subscription validity period as 2005-8-1 10:00˜2005-9-1 10:00, if a message is not published within this duration, the notification will not be sent to the watcher client, and the subscription relationship will be canceled after 2005-9-1 10:00;

2) The notification rule processing unit judges whether time of publishing presence information is within a predetermined time period. If the time of publishing presence information is not within the predetermined time period, the notification rule processing unit will notify the publishing and notification processing unit to give up sending the notification message; if it is within the predetermined time period, performs process 3). For example, the subscription validity period set by the watcher is between 8:00˜18:00 every day and the time the presence server received the published notification message is 9:00, then the condition is satisfied;

3) The notification rule processing unit judges whether number of notification message received by the watcher client in one day is up to number preset by the watcher. If the number of notification message received by the watcher client in one day is up to the number preset by the watcher, the notification rule processing unit will notify the publishing and notification processing unit to give up sending the notification message carrying presence information; or, performs process 4). There are counters for taking count of both total number of notifications and every day's number of notifications (i.e., receiving times) preset by the watcher, (for example, 1000 is the total number and 10 is every day's number). The counter for total number counts 1 whenever a notification message is sent to the watcher client; the counter for every days number counts from 0 and counts 1 whenever a notification message is sent to the watcher client. Before a notification message is sent, the notification rule processing unit judges whether the total number of sending has up to 1000, and whether the total number of notifications in the day has up to 10. If both the total number and every day's number are not up to, both the total counter and the daily counter counts 1, and sending the notification message to the watcher client. On the next day, the counter for every day's number will be cleared to 0, but the counter for total number will not.

4) The notification rule processing unit judges whether the receiving frequency preset by the watcher is exceeded. If the receiving frequency preset is exceeded, the notification rule processing unit will notify the publishing and notification processing unit to give up sending the notification message to the watcher client; if the receiving frequency preset is not exceeded, performs process 5). The receiving frequency may be preset with either of the following two methods: (1) once per 10 min. For example, beginning at 8:00, the presence server may choose to process last published information during 8:00˜8:10 and notify the watcher client of the information at 8:10, or the presence server may combine the messages published within the time of 8:00˜8:10 and then publish the messages combined by the presence server to the watcher client; (2) not more than 10 messages per minute. In this case, the presence server will process the publication message and notify the watcher client and take count of the publication message once the message is received by the presence server. In this case, if more than 10 messages are sent within 1 minute, the presence server will discard the publication messages which is received after the tenth publication message received by the presence server in 1 minute.

5) The watcher client is notified of the notification message which has been processed according to the publication procedure;

In above process, if there is no limitation condition, it is considered that the notification condition is satisfied. There is no limitation on the sequence between judgment of notification rules and treatment of publication process, thus the object of the present invention may be achieved regardless of the processing sequence. Whenever the watcher is notified of notification message, the publication count increases by one automatically. The conditions may be stored and processed in a database.

The processes and the rules and policies involved in embodiments of the invention may be implemented easily by those skilled in the art with existing programming means.

In order to make the present invention understood better, several application examples will be illustrated as follows:

### EXAMPLE 1

A radio station provides presence information service regarding road traffic conditions, and driver Zhangsan has subscribed to the service regarding road traffic conditions;

(1) Since driver Zhangsan only drives in daytime, he needn't receive information on road traffic conditions at other times;

(2) In view of frequent changes of road traffic condition information, driver Zhangsan expects to receive the presence information once per 10 minutes;

(3) Driver Zhang expects to use the service regarding road traffic conditions for only one month;

Based on Zhangsan's above demand, processing flow for subscribing to and publishing presence information is illustrated as follows:

(1) Zhangsan sends a subscription request to the presence server. The subscription request includes: the presentity identity (radio station), the type of presence information (road traffic information), the notification condition (i.e., receiving time period, 8:00˜18:30 in daytime), the receiving frequency (once per 10 minutes) and the usage period (1 month). The subscription request message contains the extended event notification filtering condition, with fields <when>, <rate>, <expire-time> added to indicate the notification rules;

(2) The presence server performs processing according to the Subscription Authorization Rules of the radio station and the subscription is assumed successful. The notification conditions described above are stored in the presence server (the notification conditions may be stored independently, or they may be stored in the filtering rules or subscription relationship);

(3) The radio station publishes the presence information of traffic conditions to the presence server at 9:00 a.m.;

(4) The presence server finds Zhangsan by the subscription relationship. If the presence server finds the usage period of one month has expired, it will stop sending the notification message to Zhangsan and cancel the subscription relationship (e.g. send a notification of canceling the subscription relationship to Zhangsan, or inquire of Zhangsan, through some ways, whether to renew the subscription and this may be implemented in the subscription process, i.e., the presence server sends a request message to Zhangsan's terminal or application server to ask him whether to renew the subscription); otherwise, it goes into the next process;

9:00 a.m. is within the predefined receiving time period (8:00˜18:30); it goes into the next process;

If the radio station publishes the presence information only once within 10 minutes, the presence information will undergo some other processing (combination, content authorization, event notification filtering, etc.), and then be transmitted to Zhangsan; if the radio station publishes presence information for several times within 10 minutes, the presence server may choose to notify Zhangsan of the presence information which is published at last time during the 10 minutes; or the presence server may also stored the presence information published at during the 10 minutes, process the information (combination, composing, etc.) and then notify Zhangsan of it.

### EXAMPLE 2

Zhangsan and Lisi are workmates in a company. They only keep workmate relationship but don't need to contact with each other at ordinary times. Zhangsan only wants to receive presence information from Li of working hours instead of other hours;

In view of Zhang's demand in Example 2, processing flow for subscribing to and publishing presence information is as follows:

(1) Zhang sends a subscription request to the presence server. The request includes: the presentity identity (Li) and the notification condition (receiving time period, 8:00˜18:30 in daytime);

(2) The presence server performs processing according to the Subscription Authorization Rules of Lisi and the subscription is assumed successful. The notification conditions described above are stored in the presence server (stored in the filtering rules or subscription relationship, or stored independently);

(3) When Lisi publishes the presence information to the presence server within 8:00˜18:30, the presence information published by Lisi is processed (combination, composing, content filtering, etc.) and then the presence information processed by the presence sever is notified to Zhangsan. However, if Lisi publishes presence information to the presence server beyond the period of 8:00˜18:30, the presence server will not send the presence information published beyond the period of 8:00˜18:30 to Zhangsan.

### EXAMPLE 3

Zhangsan and Lisi are members of a game team, and Lisi is a full-time game player, while Zhangsan has to work in daytime; Zhangsan only wants to receive presence information related to game from Lisi at other times beyond the working time period. That case may also be implemented by setting the time period, and therefore, will not be described in detail here.

Besides above receiving rules, the state of a watcher may also be taken as an element in the notification rules. In that case, the presence server will notify the watcher of the presence information further according to the state of the watcher, for example, user Zhangsan expects to receive presence information according to his state which includes:

(1) “meeting/no disturbing”: any presence information from any presentity will not be received;

(2) “at home”: any presence information related to location will not be received;

(3) “working”: any presence information related to game or presence information from certain people will not be received;

In the situation described above, a watcher may publish state information to the presence server. Generally, a watcher client also serves as a presentity client to publish its own presence information on presence state to the presence server and then the presence server update and store the presence state information of the watcher. Another situation is that the presence server queries for the presence state information of the watcher by using a certain method, for example, the presence server may search for the location information of the watcher in a Location Server. If the presence information contains location information, it is unnecessary to search for location information in the Location Server; if the presence server finds out that the state of Zhangsan is “meeting/no disturbing”, the presence server cancels sending the notification information to Zhangsan; if the state is “at home”, the presence server filters out all presence information related to location before it sends the notification information to Zhangsan; if the state is “working”, the presence server filters out all presence information related to game before it sends the notification information to Zhangsan, or the presence server may filter out presence information from certain people according to the arrangement. Such filtering rules may be defined in advance by a watcher in the Presence XDMS or presence server, and such arrangement is related to the state of the watcher.

The case that a watcher may determine, by setting notification rules, whether the presence server sends notification messages to it is described above. In next preferred embodiment, the presence server may perform processing according to the receiving frequency, receiving period, and receiving state preset by the watcher, and then notifying the presentity client to control the publication rate/frequency and period of message. For example, watcher A requests to receive presence information once every 15 minutes, and watcher B requests to receive presence information one time every 5 minutes. The receiving periods are 8:00˜16:00 and 9:00˜18:00 respectively. The presence server requests the presentity to publish presence information one time every 5 minutes, and the presence server sends the presence information once to watcher A and three times to watcher B within 15 minutes. Actually, the presentity publishes presence information three times within 15 minutes, but watcher A still considers that the presentity only published the presence information once within 15 minutes. Particular implementation process is described as follows:

1) Watchers A and B send a subscription request to the subscription processing unit. In the subscription request, it is indicated that the receiving frequency is one time every 15 minutes and one time every 5 minutes respectively, and the receiving period is 8:00˜16:00 and 9:00˜18:00. After the subscription of watchers A and B is successful, the subscription relationship and notification rules are stored, respectively;

2) The notification rule processing unit determines that there exists notification rules (receive policy) defined by watchers A and B, and finds that the two notification rules are for the same presentity. The presence server processes the notification rules from watchers A and B and notification rules defined by other watchers for this presentity (assumed the processing principle as taking the union of the periods, and taking the higher transmission frequency), and determines that the demands of watchers A and B may be satisfied as long as presence information is sent every 5 minutes or less by the presentity in time period 8:00˜18:00, thereby, the notification rule processing unit sends a control request to the presentity client to specify that the sending frequency shall not be higher than one time every 5 minutes and the sending period shall be 8:00˜18:00 every day.

3) The presentity client or application server which is subscribed to receives the control request from the presence server and stores the control conditions. Once the presence information of the presentity client or application server changes and therefore needs to be published, the presentity client or application server first judges whether the control conditions sent from the presence server are satisfied, i.e., whether its publication frequency is higher than one time every 5 minutes, and whether the current sending time is within 8:00˜18:00. If all of these conditions are satisfied, the presence information may be published; otherwise the publication will be canceled.

4) If the presentity finds that the control conditions are satisfied, it will publish presence information to the publishing and notification processing unit. The current time is assumed as 8:30, the publishing and notification processing unit requests the notification rule processing unit to process, and it is assumed that the interval between the current publication and the end of the last frequency period is not longer than 5 minutes, then the frequency of one time every 5 minutes which is required by watcher B is satisfied but the frequency of one time every 15 minutes which is required by watcher A is not satisfied. The notification rule processing unit judges that the publication time meets the requirement of watcher A but doesn't meet the requirement of watcher B, and then returns the result to the publishing and notification processing unit;

5) The publishing and notification processing unit judges whether notification message needs to be sent to watchers A and B in accordance with the result returned from the notification rule processing unit.

As a preferred embodiment, if all of the watchers are in a state that they can not receive presence information, the presence server may notify the presentity client or application server not to publish presence information during this period; when there is a watcher in receiving state, the presence server may notify the presentity to continue to publish.

Those skilled in the art may implement the technical solution described in the present invention by existing technical means, without any creative effort.

While the present invention has been illustrated and described with reference to some prefer-red embodiments, the present invention is not limited to these. Those skilled in the art should recognize that various variations and modifications can be made without departing from the spirit and scope of the present invention as defined by the accompanying claims.

1. A method for notifying presence information, comprising:
subscribing to, by a watcher client, presence information of a presentity via a presence server;
receiving, by the presence server, a PUBLISH message from a presentity client, and determining to send a notification message to the watcher according to a notification rule defined by the watcher client, and sending the notification message to the watcher client.

2. The method for notifying presence information according to claim 1, further comprising:
processing, by the presence server, the PUBLISH message according to a content-related process rule predefined by the watcher client and the presentity client, and determining whether to send the PUBLISH message processed by the presence server to the watcher client according to the notification rule.

3. The method for notifying presence information according to claim 1, further comprising:
judging, by the presence server, there is a notification rule defined by the watcher after the presence server receives the PUBLISH message, and triggering a process of determining whether to publish the message to the watcher client, according to the notification rule defined by the watcher.

4. The method for notifying presence information according to claim 1, further comprising:
determining there is a notification rule defined in the SUBSCRIBE message, and storing the notification rule.

5. The method for notifying presence information according to claim 1, wherein the notification rule is predefined in a Presence XDMS or presence server by the watcher client.

6. The method for notifying presence information according to claim 1, wherein the process of determining to send a notification message to the watcher client according to the notification rule defined by the watcher comprises at least one of the following processes:
determining that a subscription validity period has not expired;
determining that the time of receiving the PUBLISH message is within a predetermined time period;
determining that number of notification message received by the watcher client in one day is not up to number preset by the watcher;
determining that the notification message is to be published to the watcher client at present according to a defined receiving frequency of the watcher or the state of the watcher and the corresponding notification rule.

7. The method for notifying presence information according to claim 1, further comprising:
processing, by the presence server, the notification rule and sending the result of the processing or receiving state of the watcher client to the presentity client;
determining, by the presentity client, the publication of information according to the result or the receiving state of the watcher client.

8. The method for notifying presence information according to claim 1, further comprising:
updating, by the watcher client, the notification rule by means of subscription or modifying the notification rule on a WEB interface.

9. A presence server, comprising:
a publishing and notification processing unit, configured to find a watcher according to subscription relationship, and obtain a judgment result, and determine whether to publish the message to the watcher according to the judgment result;
a notification rule processing unit, configured to judge whether notification condition is satisfied according to notification rule and provide the judgment result to the publishing and notification processing unit.

10. The system for notifying presence information according to claim 9, wherein the notification rule processing unit is arranged separately in the presence server or is arranged in the publishing and notification processing unit which is in the presence server.

11. The system for notifying presence information according to claim 9, further comprising:
a subscription processing unit, configured to determine there is a notification rule defined in subscription message from the watcher client, and stores the notification rule.

12. The system for notifying presence information according to claim 9, wherein the notification rule is predefined by the watcher client in the Presence XDMS or presence server.

13. The system for notifying presence information according to claim 9, wherein the notification rule processing unit is configured to carries out at least one of the following processes:
determining that a subscription validity period has not expired;
determining that the time of receiving the PUBLISH message is within a predetermined time period;
determining that an upper-limit of the number of receptions is exceeded;
determining that the notification message is to be published to the watcher client at present according to a defined receiving frequency of the watcher or the state of the watcher and the corresponding notification rule.

14. The system for notifying presence information according to claim 9, wherein the publishing and notification processing unit is further configured for processing the notification rule if the publishing and notification processing unit detects the notification rule defined by the watcher, and sending the result of the processing and/or receiving state of the watcher to the presentity client, and the presentity client determines to send the notification message to the watcher according to the result and/or the receiving state of the watcher.

15. The system for notifying presence information according to claim 9, further comprising:
an interface for modifying notification rule, wherein the watcher updates the notification rule by means of subscription and/or modifies the notification rule on a WEB interface via the interface for modifying.

16. A client, comprising a notification rule transmission unit, configured to send to a presence server a determined condition, as the notification rule, for determining whether to send to the client.

17. A method for notifying presence information, comprising:
subscribing to, by a watcher client, presence information of a presentity via a presence server;
determining, by the presence server, to notify the presence information to the watcher client according to a state of the watcher client and a notification rule defined based on the state of the watcher, and sending a notification message to the watcher client.

18. The method for notifying presence information according to claim 17, further comprising predefining, by the watcher client, a notification rule for the presence server.

19. The method for notifying presence information according to claim 18, wherein the predefining notification rule for the presence server comprises at least one of the following processes:
defining, by the watcher, a notification rule in the Presence XDMS by using XCAP protocol; and/or
defining, by the watcher, a notification rule in a presence information subscription message sent to the presence server.

20. A system for notifying presence information, comprising:
a watcher client, configured to subscribe presence information of a presentity via a presence server;
a presence server, configured to receive a PUBLISH message from a presentity client, and determining to send a notification message to the watcher client according to a notification rule defined by the watcher client, and sending the notification message to the watcher client

21. The system according to claim 20, wherein the presence server is further configured to process the PUBLISH message according to a content-related process rule predefined by the watcher client and the presentity client, and determine whether to send the PUBLISH message processed by the presence server to the watcher client according to the notification rule.

22. The system according to claim 20, wherein the presence server is further configured to judge there is a notification rule defined by the watcher client after the presence server receives the PUBLISH message, and trigger a process of determining whether to publish the message to the watcher client, according to the notification rule defined by the watcher.
